(19) United States
(12) Patent Application Publication
(10) Pub. No.: US 2009/0223998 A1
(43) Pub. Date: Sep. 10, 2009

(54) Convered dispensing jug for bagged liquids

(76) Inventor: David G. Cameron, Barrie (CA)

Correspondence Address: David G. CAMERON, 31 RED OAK DRIVE, BARRIE, ON, L4N 9M3, CA

(21) Appl. No.: 12/073,586

(22) Filed: Mar. 7, 2008

(51) Int. Cl. B67D 5/00; B65D 35/56; A47G 19/14

(52) U.S. Cl. 222/83.5; 222/105; 222/465.1

(57) ABSTRACT

A dispensing jug for bagged liquids such as milk has a removable, apertured cover, that retains the plastic bag within the jug, and prevents loss of pouring control due to bag slippage. Applying the rearwardly tapered cover pressurizes the unopened bag and pushes the front corner of the bag through the upward or forward facing aperture of the cover, where it may be pierced or severed. Some covers fit outside the lip of the jug; others fit within the lip of the jug; side windows reveal the contents of the bag within the jug, and may be conformed to spell out MILK, JUICE, etc; and one cover incorporates a flow control valve and a bag-piercing blade.

### BACKGROUND OF THE INVENTION

1. This invention is directed to a dispensing jug for dispensing a liquid contained in a flexible plastic bag, and in particular to such a jug having a covering lid to retain the bagged liquid within the jug.

2. Widespread use is presently made of dispensing jugs that contain a bagged liquid such as milk. The jugs are substantially conformed in size and form with the liquid-filled bags, so that the outer wall surfaces of the bag when full conform to, and tend to adhere to the inner surfaces of the wall of the jug. This stabilization of the bag of liquid by the jug enables perforation of the top of the bag within the jug, and subsequent dispensing of the liquid out of the bag. However, as the volume of the liquid within the bag diminishes, the bag frequently loses its adherence with the walls of the jug, and becomes unstable, such that it may even become dislodged within the jug during the pouring of the residual liquid. This can lead to irregular or totally uncontrolled flow of the liquid from the bag, with the possibility of undesired spillage.

### BRIEF SUMMARY OF THE INVENTION

The present invention provides a dispensing jug for bagged liquids, the jug having a cover that retains the bag within the jug. The jug cover has an aperture through which the contained liquid can be dispensed.

In a first embodiment the aperture of the cover is sized and positioned such that, with a filled, imperforate bag of liquid inserted in the jug, upon closure of the jug cover the bag is pressurized, causing the top forward corner of the bag to protrude through the cover aperture, such that it may be readily cut off, to enable dispensing of the bagged liquid.

In a further covered embodiment, the jug may have at least one elongated window in the jug wall, for viewing the level of liquid contents within the bag. In a preferred embodiment two such vertically oriented viewing windows are located in mutually opposed relation in the side wall portions of the jug.

Other embodiments include the provision of a jug with a cover having a small, forwardly oriented aperture to limit accidental inward displacement of the perforated bag corner; a jug cover provided with a perforating blade and a controllable pouring aperture; and a jug wherein the level viewing window also serves to name the contents, such as milk or juice.

While the lids are illustrated as being removable lids, it will be understood that lids may be hinged to the body of the jug, and may comprise more than one such hinged portion. The governing criteria for the lids is the capability of permitting insertion of a bag of liquid, access to pierce or open the bag, and retention of the bag within the jug.

The present invention thus provides a jug for use with a sealed, substantially rectangular-sided plastic bag containing a liquid comestible, the jug having a body portion to receive the bag in inserted, close fitting relation within the jug, a jug cover cooperable with the jug body portion to enclose an upper, gas-filled portion of the bag in compressive relation therein; the cover having an outlet aperture to receive an upper corner of the bag in projecting relation therethrough, whereby in use the bag may be readily perforated to enable pouring of the liquid through the outlet aperture, and the bag may be securely retained within the jug by the cover.

The jug may include an elongated, upwardly extending viewing aperture in a sidewall portion of the jug, for viewing the level of contents within the bag.

The jug viewing aperture may be a sealed window, enabling the use of the jug to receive and dispense un-bagged, free liquids.

The jug body portion has a substantially oval shape when viewed from above, a handle portion extending rearwardly of the jug; a frontal portion of the jug located oppositely from the handle portion may extend above the handle and the major rim portion of the jug body, to receive the cover in attached relation with the jug body.

The upper surface portion of the cover is preferably inclined downwardly and rearwardly, having the outlet aperture located in an upper, forward portion of the surface. In one embodiment the cover aperture opens substantially upwardly of the jug In another embodiment the cover aperture opens substantially forwardly of the jug. The jug contents viewing aperture may be configured in the form of the letters of a word connotive of the jug contents, the letters being arranged in mutually surmounted relation. The jug may have two mutually opposed viewing apertures that may be sealed. In an embodiment having a piercing blade extending downwardly from the cover into the jug, the cover has a lower enclosing surface that encloses the jug portion, in use to compress the sealed bag into piercing engagement with the piercing blade; and an externally connected aperture in the enclosing surface, for passage of liquid from a pierced bag when poured from the jug. The externally connected aperture may form part of a closure valve that enables the control of liquid discharge from the jug.

### BRIEF DESCRIPTION OF THE SEVERAL VIEWS OF THE DRAWING

Certain embodiments of the invention are illustrated, by way of example, without limitation of the invention thereto, other than as set forth in the accompanying claims; it being understood that further embodiments may be derived by one skilled in the art. Reference is made to the accompanying drawings, wherein:

FIG. 1 is a side perspective view of a first embodiment of a covered dispensing jug in accordance with the present invention;

FIG. 2 is a view similar to FIG. 1 of a second embodiment of the subject jug;

FIG. 3 is a side view of the externally applied jug cover of FIGS. 1 and 2;

FIG. 4 is an underview of the cover of FIG. 3;

FIG. 5 is a side elevation of a further, inserted jug cover embodiment;

FIG. 6 is a side perspective of a jug for use with the inserted FIG. 5 jug cover;

FIG. 7 is a side perspective view of a modified jug embodiment having an upstanding collar;

FIG. 8 is a side view of the cover for the FIG. 7 jug embodiment;

FIG. 9 is a front elevation of a jug cover having a piercing blade and flow control valve;

FIG. 10 is a side elevation, in section taken at 10-10 of FIG. 9, and

FIG. 11 is a side perspective of a window-labelled jug with a cover having a forward facing cover aperture.

### DETAILED DESCRIPTION OF THE INVENTION

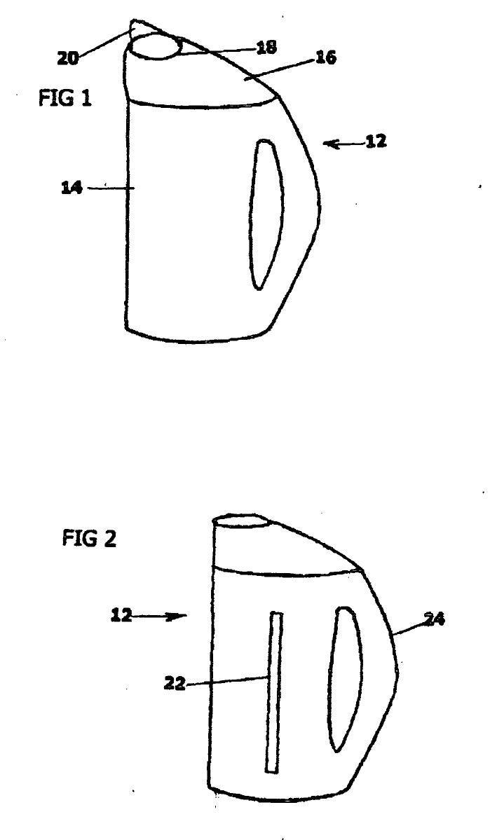

Referring to FIG. 1, a jug 12, for dispensing bagged liquids such as a milk has a container 14 to receive the bagged liquid. A cover 16 having an aperture 18 secures to the top of the container 14.

The container 14 and cover 16 are sized in relation to a standard flexible plastic bag of liquid such that the liquid containing portion of the bag substantially fills the container 14, and an air-filled upper portion of the plastic bag projects above the rim of container 14.

Application of the rearwardly tapered cover 16 into secured relation to the container 14 serves to lightly pressurize the bag and push the bag upper front corner 20 out through the aperture 18, where the bag corner 20 can be readily pierced or cut-off.

In the FIG. 2 embodiment, a viewing window 22 in one or both sides of the jug 12 permits visual determination of the remaining contents of the clear plastic bag.

It is contemplated that a narrow open slit window may be used, being sufficiently wide to afford visual access, and too narrow for the bag to extrude through.

An enclosed handle 24 facilitates handling of the jug, particularly when full.

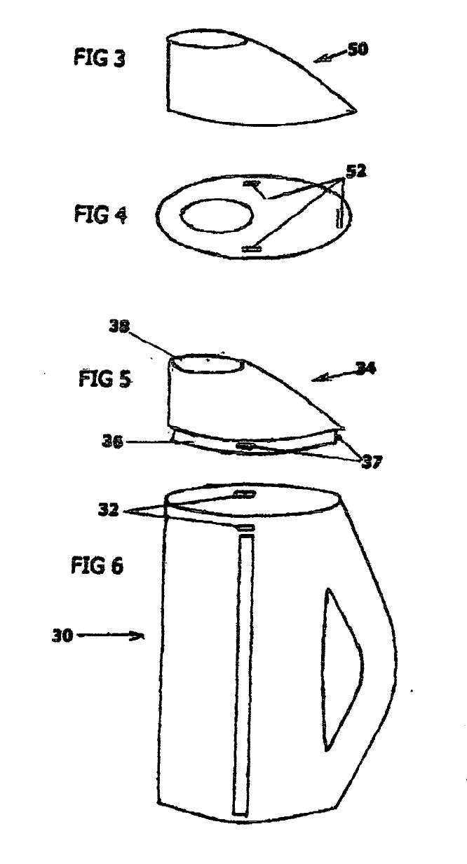

Turning to FIGS. 3 through 6, the jug 30 (FIG. 6) includes cover attachment means in the form of two or more slots 32.

Referring to FIG. 3, the cover 50 is an outer-fitting cover, shown with pairs of ribs 52 (FIG. 4) that engage the upper lip of a jug, to secure the cover 50 in place. The cover 34 (FIG. 5) has an inset rim 36 with lugs 37 to engage the slots 32. The cover 34 is illustrated as having an upward facing aperture 38.

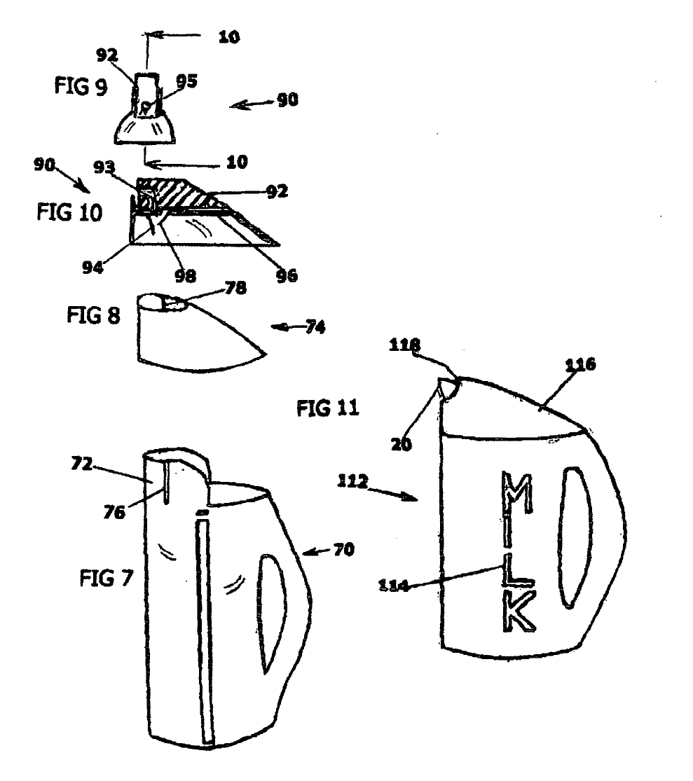

In the FIGS. 7 and 8 jug 70 and cover 74 combination embodiment, an upward extension 72 of the jug 70, extending above the rim of the jug, receives the cover 74 in downward sliding, enclosing relation. Two pairs of moulded guides 76 on the outer surfaces of extension 72 receive in sliding relation a pair of vertical ribs 78 located within the cover 74, to retain the cover 74 in place.

It will be understood that a supplementary lid may be included with these embodiments.

The FIGS. 9 and 10 embodiment has a cover 90 that includes an upper, slidable flow control valve 92, and a bag piercing blade 94. A cover enclosure surface 96 has an aperture 98. The control valve 92 has a discharge inlet 93 and a discharge outlet 95. The cover 90 is secured by one or other of the attachment means shown and described above, or may be in hinged attachment

In use, upon applying the cover 90 to the underlying bag-loaded jug (not shown), the cover serves to pressurize the bag, forcing the bag upwardly against the blade 94, which pierces the forward corner portion of the bag. Rearward displacement of the control valve 92 brings the valve discharge inlet 93 into registry with the aperture 98 of the cover 90, enabling the liquid contents of the bag to be poured.

In the FIG. 11 embodiment, the jug embodiment 112 has a level-indicating window 114, configured in the word “MILK” in which at least portions of the word form a substantially continuous window or slit through which the level of contents within the jug 112 may be readily seen. The jug cover 116 has a substantially forward facing aperture 118, through which the forward corner 20 of the bag is shown. It appears that in many instances this cover embodiment may provide enhanced protection of the bag, after it has been opened, with reduced possibility for entry of contaminants.

In the case of jugs wherein the contents viewing window is a sealed entity, such jugs are entirely suited for general use, with or without the jug cover.

1. A jug for use with a sealed, substantially rectangular-sided plastic bag containing a liquid comestible, said jug having a body portion to receive said bag in inserted, close fitting relation within the jug, a cover attachable to said jug body portion to enclose an upper, gas-filled portion of said bag in compressive relation therein; said cover having an outlet aperture to receive an upper corner of said bag in projecting relation therethrough, whereby in use said bag may be readily perforated to enable pouring of said liquid through said outlet aperture, and said bag may be securely retained within said jug by said cover.

2. The jug as set forth in claim 1, said jug including an elongated, upwardly extending viewing aperture in a sidewall portion of the jug, for viewing the level of contents within said bag.

3. The jug as set forth in claim 2, wherein said viewing aperture is a sealed window, enabling the use of said jug to receive and dispense un-bagged liquids.

4. The jug as set forth in claim 1, said body portion having a substantially oval shape when viewed from above, a handle portion extending rearwardly of said jug; a frontal portion of said jug located oppositely from said handle portion extending above said handle, to receive said cover in attached relation with said jug body.

5. The jug as set forth in claim 1, wherein an upper surface portion of said cover inclines downwardly and rearwardly, having said outlet aperture located in an upper, forward portion of said surface.

6. The jug as set forth in claim 5, wherein said cover aperture opens substantially upwardly of said jug

7. The jug as set forth in claim 5, wherein said cover aperture opens substantially forwardly of said jug.

8. The jug as set forth in claim 2, wherein said viewing aperture is configured in the form of the letters of a word, said letters being arranged in mutually surmounted relation.

9. The jug as set forth in claim 8, wherein said viewing aperture is sealed.

10. A jug for use with a sealed, substantially rectangular-sided plastic bag containing a liquid comestible, said jug having a body portion to receive said liquid-filled bag in inserted, close fitting relation within the jug, a cover attachable to said jug body portion to enclose an upper, gas-filled portion of said bag in compressive relation therein; said cover having an outlet aperture for passage of said liquid from the jug; valve means located above said cover outlet aperture and moveable, in use, from a first sealing condition to seal said outlet aperture, to a second, unsealed condition of said cover aperture, to permit pouring of said liquid from said jug.

11. The jug as set forth in claim 10, including knife means secured to said cover in downwardly depending relation, to penetrate said bag, upon the application of said cover to said bag and said jug.

12. The jug as set forth in claim 10, wherein said valve is a slide valve, slidably mounted for forward and rearward displacement, relative to said jug.
